(19) United States
(12) Patent Application Publication
(10) Pub. No.: US 2020/0188999 A1
(43) Pub. Date: Jun. 18, 2020

(54) METHODS AND SYSTEMS FOR REMOVAL OF RESIDUAL MATTER FROM THREE-DIMENSIONAL COMPONENTS

(71) Applicant: General Electric Company, Schenectady, NY (US)

(72) Inventor: Andrew Lee Trimmer, Niskayuna, NY (US)

(21) Appl. No.: 16/219,978

(22) Filed: Dec. 14, 2018

(51) Int. Cl. B22F 3/105; B22F 3/24; C04B 35/64; B28B 1/00; B08B 3/02

(52) U.S. Cl. CPC B22F 3/1055; B22F 3/24; C04B 35/64; B28B 1/001; B33Y 10/00; B22F 2003/1059; B22F 2003/247; B08B 2209/005; B08B 3/024

(57) ABSTRACT

A method for removal of residual matter includes delivering an ultra high-pressure fluid jet to an intermediate additively manufactured three-dimensional (3D) component to dislodge and remove at least a portion of the residual matter from an internal surface of the intermediate additively manufactured 3D component, or from an external surface of the intermediate additively manufactured 3D component, or both, to form a cleansed additively manufactured 3D component.

### BACKGROUND

Embodiments of the present specification relate to additively manufactured components, and more particularly, embodiments of the present specification relate to removal of residual matter from additively manufactured three-dimensional (3D) components.

Additive manufacturing provides cost effective and time efficient ways of making 3D components. The additively manufactured 3D components may have complex shapes that may include complex interior structures, such as chambers, channels, cavities, protrusions, plenums, and the like. Additive manufacturing facilitates manufacturing of the relatively complex internal passage geometry while reducing assembly details, reducing quantity of material used, modifying designs of products, reducing waste production, and saving energy costs, as compared to conventional manufacturing techniques. Consequently, additive manufacturing to fabricate complex structures facilitates savings in terms of cost, material, and time.

Generally, additive manufacturing of the 3D components requires post-processing or post manufacturing operation process steps to provide the 3D component in its finished form. For example, additive manufacturing typically results in some amount of residual matter that is inadvertently left in the 3D components. This residual matter needs to be removed before a 3D component can be deployed for its intended purpose. For example, powder bed based additive manufacturing processes may involve time-consuming post manufacturing operation steps to remove the residual powder. By way of example, the post manufacturing operation steps may include processes to remove residual powder, partly sintered powder particles, and the like. Maximizing removal of such residual matter from the intricate interior structure of the 3D component without adversely affecting the interior structure of the 3D component is highly desirable.

Presently, several methods are employed to remove residual matter from the formed additive manufactured components. In some methods, abrasive slurry may be sprayed on the 3D component to facilitate removal of conglomerated powder. In some other methods, ultrasonic cleaning of the 3D component may be used to remove the residual matter. The ultrasonic cleaning may be followed by exposure of the 3D component to a suitable solution to dissolve the residual matter that may be displaced from their location due to the ultrasonic cleaning. In some methods, the 3D component may be immersed in a fluid medium, followed by mechanical agitation, such as agitation at ultrasonic frequency, sweeping, pulsing motions at a determined time and temperature, and the like.

Some other techniques for removal of the residual matter from the 3D component include forming an integrated tool within the 3D component, such as an elongated member, a wire cutter, and the like. The tool is then agitated to remove the residual powder. Mechanical forces, such as by hammering may be used to dislodge the residual matter. While some of the existing methods may be able to at least partly facilitate dislodging of the particles from their place in the 3D component, removing the residual matter from within the internal passages or interior structure of the 3D component is also highly desirable.

### BRIEF DESCRIPTION

In one embodiment, a method for removal of residual matter includes delivering an ultra high-pressure fluid jet to an intermediate additively manufactured three-dimensional (3D) component to dislodge and remove at least a portion of the residual matter from an internal surface of the intermediate additively manufactured 3D component, or from an external surface of the intermediate additively manufactured 3D component, or both, to form a cleansed additively manufactured 3D component.

In another embodiment, a method for additively manufacturing a cleansed additively manufactured 3D component includes additively manufacturing an intermediate additively manufactured 3D component. The method further includes removing at least a portion of residual matter from the intermediate additively manufactured 3D component by delivering an ultra high-pressure fluid jet to the intermediate additively manufactured 3D component to dislodge and remove at least a portion of the residual matter from an internal surface of the intermediate additively manufactured 3D component, or an external surface of the intermediate additively manufactured 3D component, or both, to form the cleansed additively manufactured 3D component. The ultra high-pressure fluid jet includes a pressure of 10,000 psi to 70,000 psi.

In yet another embodiment, a cleansing system includes a chamber having a base and walls. The cleansing system further includes a holder disposed on the base of the chamber, where the holder is configured to receive an intermediate additively manufactured 3D component. Further, the cleansing system also includes an ultra high-pressure fluid jet configured to dislodge and remove at least a portion of the residual matter from an internal surface of the intermediate additively manufactured 3D component, or from an external surface of the intermediate additively manufactured 3D component, or both, to form a cleansed additively manufactured 3D component.

### DRAWINGS

These and other features and aspects of embodiments of the invention will become better understood when the following detailed description is read with reference to the accompanying drawings in which like characters represent like parts throughout the drawings, wherein:

FIG. 1 is a pictorial representation of an additively manufactured three-dimensional (3D) component, in accordance with aspects of the present specification;

FIGS. 2-3 are pictorial representations of additively manufactured intermediate 3D components having residual matter, in accordance with aspects of the present specification;

FIGS. 4-5 are flow charts of methods for removal of residual matter from an intermediate additively manufactured 3D component, in accordance with aspects of the present specification; and

FIG. 6 is a schematic representation of a cleansing system for removal of residual matter from an intermediate additively manufactured 3D component to form a cleansed additively manufactured 3D component.

### DETAILED DESCRIPTION

Embodiments of the present specification are directed to methods and systems for removal of residual matter from a three-dimensional (3D) component using an ultra high-pressure fluid jet. The residual matter may include loose or partly sintered powder particles trapped or disposed in at least a portion of an internal surface, an external surface, or both the internal and external surfaces of the 3D component.

As used herein, the term “intermediate additively manufactured 3D component” refers to an additively manufactured component that has not yet been subjected to any subsequent process steps post additive manufacturing of the intermediate additively manufactured 3D component. It may be noted that the terms “intermediate additively manufactured 3D component” and “intermediate component” have been used interchangeably throughout the present specification.

Further, as used herein, the term “cleansed additively manufactured 3D component” refers to the intermediate component that has been subjected to the method of the present specification for removal of the residual matter. It may be noted that the terms “cleansed additively manufactured 3D component,” “3D component” and “cleansed component” have been used interchangeably throughout the present specification.

As used herein, the term “loose particles” refers to particles that are not bonded or fused to an internal and/or external surface of the intermediate component. Also, as used herein, the term “partly sintered particles” refers to particles or agglomerates of the particles that are incompletely or only partially sintered and fused to an internal and/or external surface of the intermediate component. As used herein, the term “agglomerates” refers to a cluster of particles that may or may not be fused or sintered together. It may be noted that the terms “internal surface” and “external surface” may refer to surfaces of the intermediate component or the cleansed component, and/or surfaces of features of the intermediate and/or cleansed component. Further, it may be noted that the terms, “ultra high-pressure fluid jet” and “fluid jet” are used interchangeably throughout the present specification.

In embodiments of the present specification, the intermediate additively manufactured 3D component may include residual matter in the form of loose particles or agglomerate of loose particles, partly sintered particles or agglomerates of partly sintered particles, or combinations thereof. Further, the residual matter may be disposed in at least a portion of the intermediate additively manufactured 3D component.

In certain embodiments, the residual matter is at least partly bonded to the inner surface and/or an external surface of the intermediate component due to incomplete or partial sintering. The residual matter may be partially fused or bonded to the internal and/or external surface of the intermediate product due to partial sintering or any other thermal treatment during additive manufacturing of the intermediate component.

The intermediate component may include an internal structure that is defined by the internal and/or external surfaces of the intermediate component. The internal structure may have one or more features, such as, but not limited to, a concave shape, a convex shape, an irregular shape, a porous matrix, an internal passage, a cavity, a hole, a duct, a recess, a channel, a protrusion, a mesh structure, a plenum, or the like. The features may have uniform or non-uniform cross-sectional areas. Further, the internal structure may include one or more bends, curves, curvatures, and continuous or discrete segments. In some embodiments, the internal structure of the intermediate component may have a complex structure having a non line-of-sight geometry. The intermediate component may be an aviation component, aircraft structure, aviation engine component, healthcare component, other industrial machinery, or domestic appliances. In one embodiment, the intermediate component may be a section of a gas-turbine engine, such as a combustor section, a compressor section, and the like.

In certain embodiments, the intermediate components may be additively manufactured using layer-by-layer processes. In additive manufacturing, the layer-by-layer processes sequentially build-up layers of atomized metallic alloy and/or ceramic powder materials. Non-limiting examples of such powder materials include=steel alloys, stainless steel alloys, aluminum-based alloys, nickel-based superalloys, titanium-based alloys, copper-based alloys, chromium-based alloys, cobalt based alloys, and other chemical combinations of micron scale particles that are suitable for specialized layer-by-layer additive processing.

In some embodiments, the intermediate components may be manufactured using an additive manufacturing process, such as, but not limited to, direct selective laser sintering (DSLS), laser engineered net shaping (LENS), stereolithography (SLA), electron beam sintering (EBS), electron beam melting (EBM), laser net shape manufacturing (LNSM), directed energy deposition (DED), laser powder bed fusion (LPBF), hybrid additive manufacturing, binder jet, cold spray, and others. Although only particular additive manufacturing processes are described, it should be noted that other suitable additive manufacturing methods using layer-by-layer construction or additive fabrication may be alternatively or additionally used.

In certain embodiments of the present specification, the additive manufacturing process is used to fabricate an intermediate component by deploying a computer model that uses spatial information regarding a 3D structure of the intermediate component, for one or both of the internal and external surfaces of the intermediate component. This spatial information regarding the 3D structure of the component may be provided as a computer model or software, and is referred to as a “tool path instruction.”

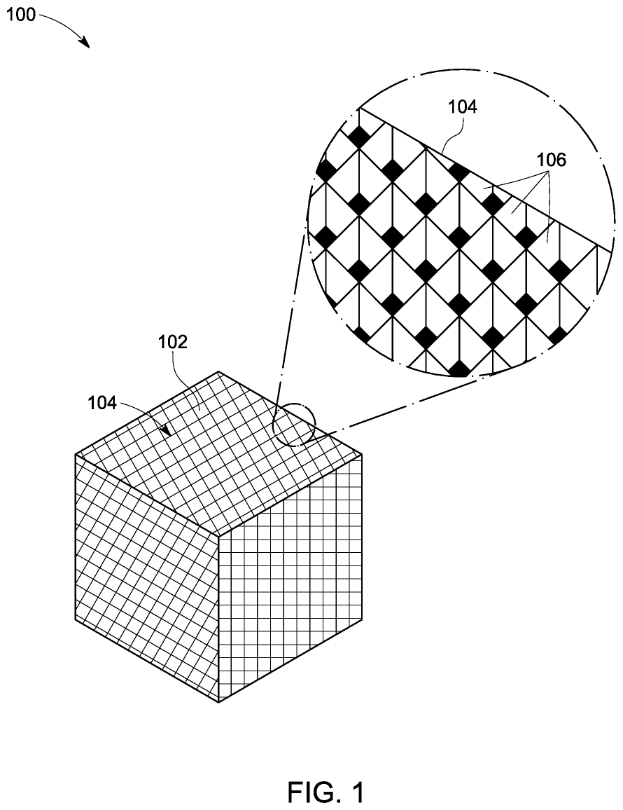

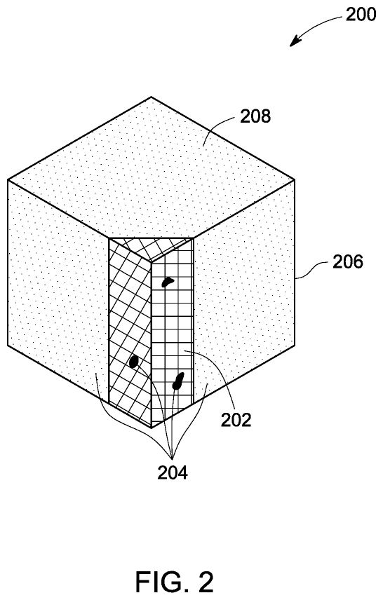

FIG. 1 illustrates a representative cleansed additively manufactured 3D component, generally represented by reference numeral 100, while FIG. 2 illustrates a corresponding intermediate additively manufactured 3D component 200. As illustrated in FIG. 1, the cleansed component 100 includes an external surface 102. The cleansed component 100 includes a complex internal structure, such as a mesh or lattice structure represented by reference numeral 104. The mesh structure 104 includes a plurality of pores 106. The cleansed component 100 is obtained by subjecting the intermediate component 200 to methods of the present specification for removal of residual matter. During additive manufacturing of the intermediate component 200, the residual matter may get lodged in some of the pores 106 of the mesh structure 104. It is desirable to dislodge and remove the residual matter prior to using the intermediate component 200 for its intended use. The intermediate component 200 may or may not be subjected to one or more post-manufacturing process steps prior to being subjected to the methods of the present specification for removal of the residual matter.

As manufactured, the intermediate component 200 may include the residual matter, generally represented by reference numeral 204 (see FIG. 2). By way of example, the residual matter 204 may be present on an internal surface 202 of the intermediate component 200, an external surface 206 of the intermediate component 200, or both. The residual matter 204 may include loose particles, partly sintered particles, agglomerates, or combinations thereof, of a material used for making the intermediate component 200. The loose particles may be particles present on the internal surface 202 or the external surface 206, of the intermediate component 200 that are not bonded or fused to the internal surface 202 or the external surface 206, respectively, of the intermediate component 200. The partly sintered particles may be incompletely or partly sintered and may be present on the internal surface 202 and/or the external surface 206 of the intermediate component 200. The particles, such as the loose particles, partly sintered particles, or particles in the agglomerates, may be particles of the same powder that is used to form the intermediate component 200. Further, the residual matter 204 may also include a layer 208 of the powder used to form the intermediate component 200. The powder layer 208 may be disposed on at least a portion of the external surface 206 of the intermediate component 200.

Typically, the complex geometry of the internal structure of the intermediate component 200 may present challenges in removal of the residual matter 204 during cleansing of the intermediate component 200. In certain embodiments, at least a portion of the residual matter 204 may be machined off from the internal surface 202, the external surface 206, or both, using an ultra high-pressure fluid jet. The ultra high-pressure jet is configured to dislodge and remove at least some of the residual matter 204 from the intermediate component 200. In one example, the ultra high-pressure jet is configured to dislodge partly sintered residual matter 204 bonded to an internal surface 202 of the intermediate component 200. Moreover, once the residual matter 204 is dislodged or machined off, the ultra high-pressure fluid jet facilitates removal of washed-out particles of the residual matter 204 from the intermediate component 200 to form the cleansed component, such as the cleansed component 100 of FIG. 1.

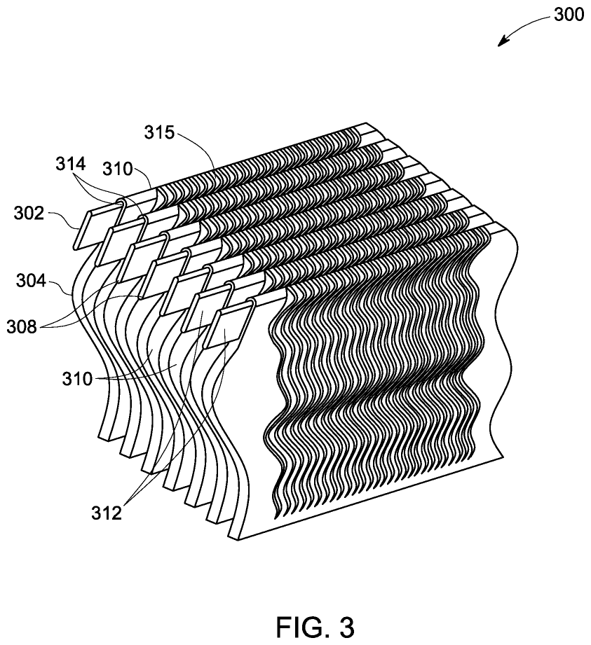

FIG. 3 illustrates an example intermediate component 300 having internal surfaces, generally represented by reference numeral 302, and external surfaces 304. The internal and external surfaces 302 and 304 together or individually form an internal structure of the intermediate component 300. The internal structure may include several different features, such as cavities 308, passages 310, protrusions 312, and plenums 314. Other non-limiting features of the internal structure may include concave shapes, convex shapes, irregular shapes, holes, porous matrix, and the like. The external surface may include corrugations 315, or other surface features. The intermediate component 300 may include residual matter disposed on the internal and/or external surfaces 302, 304. The residual matter may include loose particles, partly sintered particles, and agglomerates. The internal structure of the intermediate component 300 presents challenges in dislodging and removing the residual matter from the intermediate component 300. The ultra high-pressure fluid jet is configured to remove the residual matter from the internal or external surfaces 302 or 304, respectively, of the intermediate component 300. Advantageously, high pressure, in a range of 10,000 psi to 70,000 psi, of the fluid jet along with the flexibility with respect to an orientation, standoff distance, and the like, of the jet of the ultra high-pressure fluid jet facilitates dislodging and subsequent removal of the residual matter from the intermediate component 300. It may be noted that the range of the pressure may depend on several aspects, such as, but not limited to, geometry of the intermediate component, wall thicknesses of the intermediate component, and the like. In some embodiments, the pressure of the fluid jet may be in a range from 10,000 psi to 40,000 psi. In some embodiments, the pressure of the fluid jet may be in a range from 15,000 psi to 25,000 psi.

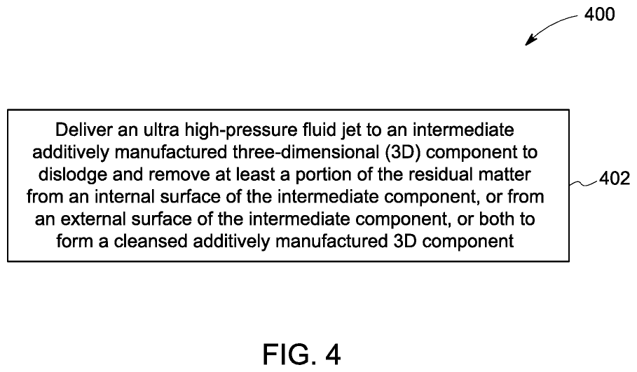

FIG. 4 illustrates a method flow chart 400 for removal of residual matter from an internal surface, an external surface, or both of an intermediate additively manufactured 3D component to form a cleansed component. It may be noted that in the method of flow chart 400, at least a portion of the residual matter may be removed from the intermediate component to form the cleansed component. At step 402, an ultra high-pressure fluid jet is delivered to the intermediate component to dislodge and remove at least a portion of the residual matter from the internal surface, the external surface, or both, of the intermediate component to form a cleansed additively manufactured 3D component. In some embodiments, the amount of the residual matter remaining in the cleansed component may be undetectable through regular detection devices or other processes.

In certain embodiments, the ultra high-pressure fluid jet includes water, a mixture of water and powder particles, an incompressible fluid, a mixture of the incompressible fluid and powder particles, or combinations thereof. The incompressible fluid may include oil or other high-density fluids with tuned rheology. Tuned rheology facilitates homogenous mixing in embodiments where a mixture of the incompressible fluid and powder particles is used. Non-limiting examples of the incompressible fluid may include oil. In some embodiments, the ultra high-pressure fluid jet may include an oil or a mixture of oil and powder particles. Suitable oils may include, but are not limited to, high molecular weight hydrocarbons, mixtures of surfactants to drive desirable rheological properties, and fluids that resist phase change under larger pressure gradients. Further, in embodiments where the incompressible fluid is used in the ultra high-pressure fluid jet, the density of the fluid may be optimized for bulk convection and energy transfer to facilitate dislodging of partly sintered powder particles. By way of example, an oil may be delivered as a jet at a determined temperature to reduce the density of the oil. In embodiments where water is used as the fluid, water may be regular domestic supply water, de-mineralized water, or de-ionized water.

In some examples, the amount of the powder particles in a mixture of the fluid and powder particles may be in a range from 0.1 to 30 volume percentage. In certain embodiments, the powder particles may be made of the powder that is used to fabricate the intermediate component. By way of example, the powder particles may include titanium or nickel-based superalloy.

In certain embodiments, the ultra high-pressure fluid jet may be delivered in a continuous manner to provide a continuous mechanical shock to the residual matter that may be bonded to a surface of the intermediate component due to partial sintering. In some other embodiments, the ultra high-pressure fluid jet may be delivered in a pulse mode having a determined frequency. The pulses may be provided in a periodic or a non-periodic manner. The pulses may provide recurring mechanical shocks to facilitate dislodging of the residual matter from the inner and/or external surfaces of the intermediate component.

In some embodiments, a fluid of the ultra high-pressure fluid jet may be delivered at a pressure of 10,000 psi to 70,000 psi. The pressure of the ultra high-pressure fluid jet may be varied during the step of delivering the fluid jet. By way of a non-limiting example, at the commencement of the method for removal of the residual matter, the ultra high-pressure fluid jet may be delivered at a relatively low-pressure value to remove the loose particles by flushing out the loose particles from the intermediate component. Subsequently, the pressure of the ultra high-presure fluid jet may be increased to dislodge other residual matter. In some embodiments, the pressure values may be increased at a steady rate, and in some other embodiments, pressure values may have one or more step jumps. Also, in some embodiments, the pressure value of the ultra high-pressure fluid jet may be selected based on the material of the intermediate component, additive manufacturing technique that is used to form the intermediate component, internal structure of the intermediate component, the standoff distance between a high pressure nozzle exit and a portion of the intermediate component that is being targeted at that instant in time, the rate of motion of the fluid jet relative to the portion of the intermediate component, or combinations thereof

As will be appreciated, the ultra high-pressure fluid jet may interact differently with different surfaces or internal and external structures. By way of example, the fluid jet may interact differently with a continuous solid surface as compared to a lattice structure. In one example, the energy of the fluid jet may create an undesirable hole in a solid surface, such as a thin wall, due to the interaction force. However, since it is easier to dissipate the energy of the high-pressure jet in discontinuous structures, the same fluid jet may diverge around one or more wire-like structures, having a similar wall thickness as the solid surface. In some embodiments, replaceable and/or abradable surfaces may be used on an interior of a chamber of a cleansing system, rather than high strength materials.

In one example, a relatively low pressure may be applied for an intermediate component with an intricate and delicate internal structure, such as a artifact having an internal structure with lower wall thicknesses. Further, in embodiments where the pressure of the ultra high-pressure fluid jet is varied during the step of delivering the ultra high-pressure fluid jet to the intermediate component, the pressure may be varied in accordance with a portion of the intermediate component that is being targeted at that instant in time. In a non-limiting example, the pressure of the ultra high-pressure fluid jet may be set at a higher value for the external surface of the intermediate component, as compared to a pressure value that may be used for the internal surfaces of the intermediate component or vice versa.

In certain embodiments, in addition to the physical impact, the ultra high-pressure fluid jet may be used to deliver thermal shock to the residual matter. In these embodiments, the fluid of the ultra high-pressure may be delivered to the intermediate component at a desired temperature.

Further, in some embodiments, delivering the ultra high-pressure fluid jet includes varying one or more delivery parameters, such as, but not limited to, a relative orientation of the fluid jet with respect to the intermediate component, a relative standoff distance of the fluid jet with respect to the intermediate component, a relative rate of motion of the fluid jet and the intermediate component, an impingement angle of the fluid jet with respect to the intermediate component, or combinations of two or more delivery parameters. In certain examples, the delivery parameters, such as the relative standoff distance, orientation, impingement angle, and relative rate of motion of the ultra high-pressure fluid jet with respect to the intermediate component may be varied by moving the intermediate component, moving the fluid jet, or moving both the intermediate component and the fluid jet. In some embodiments, the delivery parameters may be varied to adjust the pressure of the fluid jet as well as to direct the ultra high-pressure fluid jet towards certain portions of the intermediate component, where the portions may not initially be in the line of sight of the ultra high-pressure jet. By way of example, the orientation of the ultra high-pressure fluid jet may be varied to allow the fluid jet to traverse at least a portion of a non-linear cavity or a passage within the intermediate component. Modifying the delivery parameters, such as the relative standoff distance and the relative orientation of the ultra high-pressure fluid jet, enables the fluid jet to be directed at different angles at the intermediate component, thereby making is plausible for the fluid jet to enter spaces in the internal structure of the intermediate component that may not be initially within the line of sight.

In some embodiments, the step of delivering the fluid jet further includes moving the ultra high-pressure fluid jet through space with respect to the intermediate component in accordance with a digital tool path instruction. The digital tool path instruction may be implemented using a computer along with suitable hardware or software. The digital tool path instruction may be configured to allow movements of the ultra high-pressure fluid jet in a desired manner through the cartesian plane to enable effective removal of the residual matter from the intermediate component.

The digital tool path instruction deployed for removal of the residual matter may be same or different from the digital tool path instruction deployed for additively fabricating the intermediate component. In one embodiment, the digital tool path instruction for removal of the residual matter may be based on the digital tool path instruction for the intermediate component. In another embodiment, the digital tool path instruction provided for the removal of residual matter may be same as the digital tool path instruction of the intermediate component. The digital tool path instruction may be computer implemented via hardware components, software components, or both.

Further, in some embodiments, the ultra high-pressure fluid jet may be coupled to a motion mechanism for enabling and/or aiding movement of the ultra high-pressure fluid jet. The motion mechanism may be a manual mechanism, an automatic mechanism, or a semi-automatic mechanism. The motion mechanism may include a linkage mechanism, an actuator, a robotic arm, or combinations thereof to navigate the ultra high-pressure fluid jet through space. In embodiments where the motion mechanism is a semi-automatic or automatic mechanism, the motion mechanism may be configured to receive and execute instructions pertaining to a tool path corresponding to the intermediate component to facilitate removal of the residual matter from the intermediate component. The instructions may be pre-stored, provided in real time, or both.

In one embodiment, the robotic arm is configured to move the ultra high-pressure fluid jet through space in a rotational motion, translational motion, oscillating motion, reciprocating motion, or combinations thereof, in accordance with a digital tool path instruction. The robotic arm may be maneuvered through the ultra high-pressure fluid jet in accordance with the tool path instructions.

In certain embodiments, after delivering the fluid jet, an effluent resulting from the step of removal of the residual matter may be collected. The effluent may include the jet fluid, powder particles, or washed-out particles of the residual matter. In one embodiment, the effluent may be analyzed to determine an amount of the residual matter that may be left in the intermediate component. By way of example, if the effluent includes the residual matter in trace amounts, it may indicate that the intermediate component is cleansed to a desirable extent.

It may be noted that occasionally a leftover fluid of the fluid jet may be inadvertently left out in the intermediate component after the cleansing step. In some of these embodiments, the residual or leftover fluid may be at least partly removed from the internal structure of the intermediate component. Non-limiting examples of methods for removing the leftover fluid may include subjecting the cleansed component to a heat treatment to, for example, vaporize the fluid such as water, blasting the cleansed component with air, using electro assisted dissolution, or chemical dissolution. The air blast may be warm air blast to evaporate the fluid or a cold air blast to push the leftover fluid out of the cleansed component.

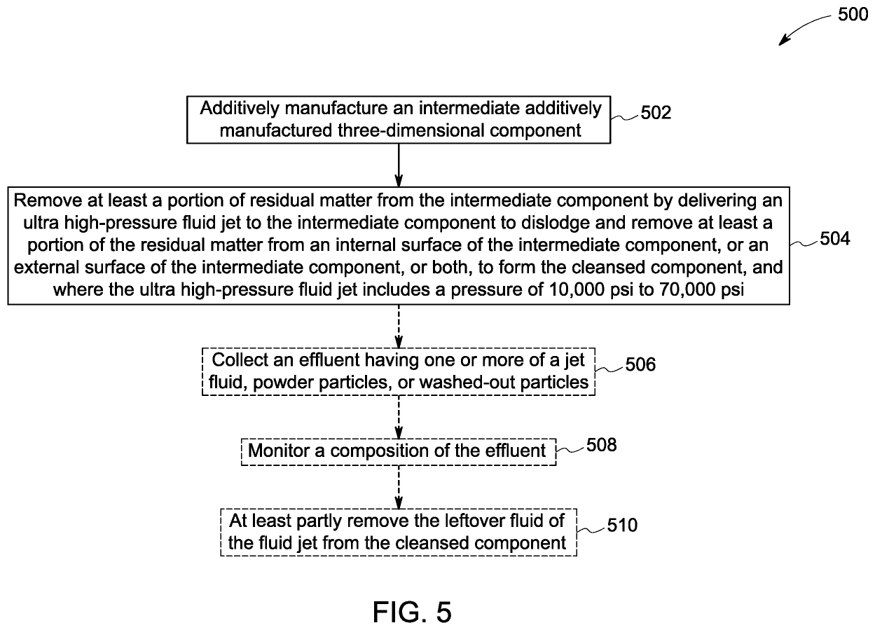

FIG. 5 is a flow chart 500 for additively manufacturing a cleansed additively manufactured 3D component. At step 502, the method commences by additively manufacturing an intermediate additively manufactured 3D component using a powder based additive manufacturing technique. Non-limiting examples of the powder based techniques may include EBM, DSLS, LENS, EBS, SLA, DMD, LPBF, LNSM, and the like.

At step 504, residual matter is removed from the intermediate additively manufactured 3D component by delivering an ultra high-pressure fluid jet to the intermediate component to dislodge and remove at least a portion of the residual matter from within the intermediate component or from an external surface of the intermediate component, or both to form the cleansed component. In certain embodiments, the ultra high-pressure fluid jet has a pressure of 10,000 psi to 70,000 psi.

Optionally, at step 506, an effluent may be collected during or after the cleansing step. The effluent may include a jet fluid, washed-out particles of the residual matter, and powder particles from a mixture of jet fluid and powder particles.

Further, optionally, at step 508, a composition of the collected effluent may be monitored to determine the amount of residual matter remaining in the intermediate component. In one example, the effluent may be filtered to determine, for example, an amount of the washed-out particles in the effluent. Based on the composition of the effluent, it may be determined whether to continue the process of removal of the residual matter.

Moreover, optionally, at step 510, if required, fluid of the fluid jet that is leftover in the internal structure of the cleansed component after removal of the residual matter may be partly removed. In some embodiments, removing the leftover jet fluid may include subjecting the cleansed component to a heat treatment, air blast treatment, electro assisted dissolution, chemical dissolution, or combinations thereof

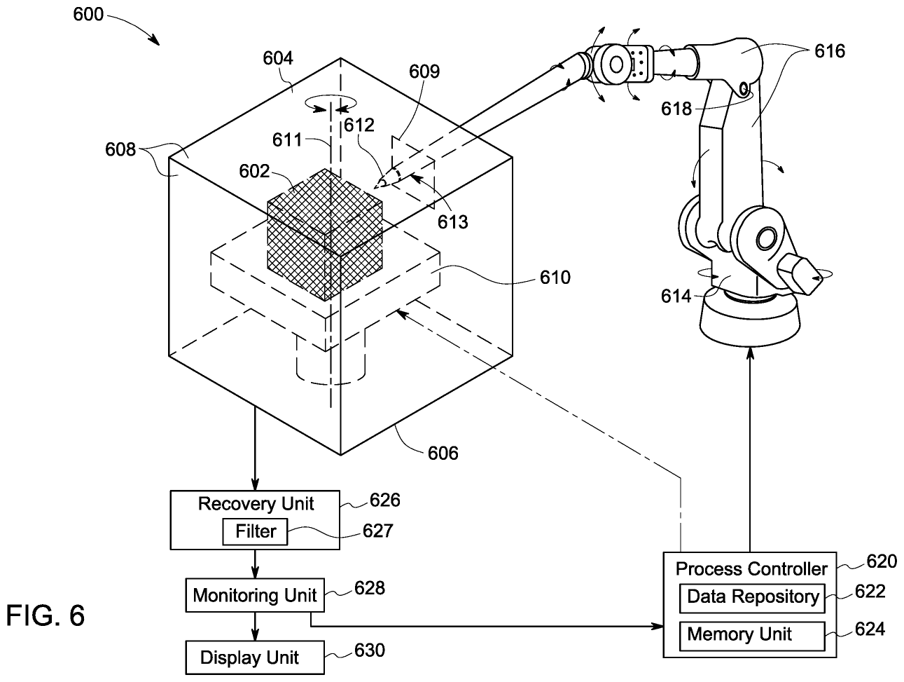

FIG. 6 illustrates a cleansing system 600 for removal of residual matter from an intermediate additively manufactured 3D component 602 to form a cleansed additively manufactured 3D component. The cleansing system 600 includes a chamber 604 having a base 606 and walls, generally represented by reference numeral 608. The chamber 604 may be made of a transparent material, such as high strength glass or translucent or opaque materials such as ceramic, metal ceramic composites, metals, metal alloys, or cermets. In certain embodiments, materials that are sacrificial, replaceable, abradable, or combinations thereof, may be used on an internal surface of the chamber 604 to at least partly absorb an impact of a jet of fluid jet and/or to at least partly prevent the fluid of the fluid jet from bouncing back from the walls 608 and/or the base 606 of the chamber 604. In one or more embodiments, one or more walls 608 of the chamber 604 may have an aperture 609 to receive an ultra high-pressure fluid jet 613 and/or a motion mechanism, such as a robotic arm 614, to direct a jet of fluid (not shown in FIG. 6) at the intermediate component 602 during the cleansing process. The ultra high-pressure fluid jet 613 includes a nozzle 612 to deliver the fluid of the ultra high-pressure fluid jet to the intermediate component 602 at desirable delivery parameters. In certain embodiments, the fluid jet is configured to deliver a pressure of 10,000 psi to 70,000 psi to the intermediate component 602. The ultra high-pressure of the fluid jet facilitates dislodging of the partly sintered residual matter, which may otherwise not be effectively dislodged by regular fluid jets having pressure values below 10,000 psi to 70,000 psi.

The cleansing system 600 further includes a holder 610 configured to receive the intermediate component 602. The holder 610 may be disposed within the chamber 604. In the illustrated embodiment, the holder 610 is coupled to the base 606 of the chamber 602. In certain embodiments, the holder 610 may be configured to rotate, retract, extend, or combinations thereof along one or more axes. In the illustrated embodiment, the holder 610 may be configured to rotate on one or more axes to change a relative orientation of the intermediate component 602 in the chamber 604 with respect to the fluid jet. By way of example, during the cleansing process, the holder 610 may be rotated along the longitudinal axis 611 while the ultra high-pressure fluid jet is being delivered.

In addition to the movement of the holder 610 or alternative to the movement of the holder 610, the ultra high-pressure fluid jet 613 may be navigated through space using a robotic arm 614 or another actuator (not shown in FIG. 6) coupled to the fluid jet. The robotic arm 614 or the actuator is configured to receive and execute instructions pertaining to a tool path corresponding to the intermediate component 602 to facilitate removal of the residual matter from the intermediate component 602. In the illustrated embodiment, the ultra high-pressure fluid jet 613 is mounted on the robotic arm 614. The robotic arm 614 is configured to carry out movements including, but not limited to, bending, rotating, traversing, or combinations thereof, to realize a pattern in space corresponding to the digital tool path instruction of the intermediate component 602. In certain embodiments, the robotic arm 614 may include one or more arm portions 616, flexibly coupled to one another using one or more joints 618. The joints 618 enable the arm portions 616 to rotate/turn about a joint axis to provide at least five degrees of freedom to enable the robotic arm 614 to be positioned at a desired relative position and angle with respect to the intermediate component 602.

Further, the cleansing system 600 includes a process controller 620 coupled to the robotic arm 614 and/or the holder 610 to control movements/operation of the robotic arm 614 and/or the holder 610 to change one or more delivery parameters, such as a relative standoff distance and/or an orientation of the intermediate component 602 and the ultra high-pressure fluid jet 613. In some embodiments, the tool path instruction may be provided to the process controller 620 in the form of a hardware or software module. Further, in some embodiments, the process controller 620 may be configured to follow and execute the digital tool path instruction to enable movement of the robotic arm 614 through space for effective removal of the residual matter from the intermediate component 602. Additionally, or alternatively, the process controller 620 may be configured to control a temperature of the fluid before the fluid is delivered to the intermediate product 602.

The process controller 620, for example, may include one or more application-specific processors, graphical processing units, digital signal processors, microcomputers, microcontrollers, application specific integrated circuits (ASICs), field programmable gate arrays (FPGAs), programmable logic arrays (PLAs), and/or other suitable processing devices. Alternatively, the process controller 620 may be configured to store the tool path instruction and/or the user input in a data repository 622 and/or in a memory unit 624 for later use. In one embodiment, the data repository 622, for example, may include a hard disk drive, a floppy disk drive, a compact disk-read/write (CD-R/W) drive, a digital versatile disc (DVD) drive, a flash drive, and/or a solid-state storage device.

In some embodiments, the cleansing system 600 may include a recovery unit 626 configured to at least partly recover an effluent from the chamber 604. The effluent from the chamber may include a jet fluid of the ultra high-pressure fluid jet and washed-out particles of the residual matter that have been dislodged from the intermediate component 602. In instances where the fluid of the ultra high-pressure fluid jet includes a mixture of powder particles and a fluid, the effluent may additionally include the powder particles from the mixture of the fluid jet. It may be noted that the washed-out particles of the residual matter may be in the form of agglomerates, individual particles, or combinations of both. The recovery unit 626 may be coupled to an outlet of the chamber 604. In certain embodiments, the recovery unit 626 may include one or more filters 627 to segregate solid matter, such as washed-out residual matter or powder particles, from the fluid of the ultra high-pressure fluid jet 613.

In certain embodiments, the cleansing system 600 includes a monitoring unit 628 configured to monitor a recovered effluent from the recovery unit 626. The monitoring unit 628 is coupled to the recovery unit 626. Further, the monitoring unit 628 is also coupled to the process controller 620. The monitoring unit 628 may be used to determine or assess an amount of the washed-out residual matter and/or particles in the recovered effluent. Based on the amount of the washed-out particles of the residual matter in the recovered effluent, a decision may be made whether to continue the cleansing process of the intermediate product 602. By way of example, if the amount of the washed-out particles of the residual matter is below a certain threshold value, a decision may be made to stop the cleansing process. The threshold value may depend on aspects, such as, but not limited to, a base material of the intermediate component 602, an internal structure of the intermediate component 602. In some embodiments, the decision to continue or stop the cleansing process may be made by the monitoring unit 628 or the process controller 620, or collectively by the monitoring and process controller units 628 and 620. In some other embodiments, the decision regarding the cleansing process may be made manually by the user based on a displayed image and/or data displayed on a display unit 630, such as, but not limited to, a touch screen. In certain other embodiments, if the amount of the washed-out particles is lower than the threshold value, a signal, such as an audio signal or a visual signal (light signal), may be generated to communicate to the user or the operator the need to stop the process. In certain embodiments, the cleansing system 600 may include a user interface device (not shown in FIG. 6) configured to aid the user to manually navigate the fluid jet, to manipulate or alter the threshold value, parameters of the fluid jet, such as position, temperature, and the like. The user interface device may include a mouse-type device, a trackball, a joystick, a stylus, or a touch screen.

The monitoring unit 628 may include suitable hardware and/or software, such as, but not limited to, one or more application-specific processors, graphical processing units, digital signal processors, microcomputers, microcontrollers, ASICs, FPGAs, PLAs, and/or other suitable processing devices. The monitoring unit 628 may include or may be coupled to one or more imaging systems, such as, an X-ray system, an ultrasound system, or any other suitable photo or acoustic radiation-based imaging system that may be configured to image the intermediate component 602 and/or cleansed component to assess the amount of cleaning that has been performed or that remains to be performed. Imaging may be performed intermittently or continually. Alternatively, momentum-based measurements may be used to assess the amount of cleansing that has been performed for the intermediate component 602.

It may be noted that although the process controller 620 and the monitoring unit 628 are illustrated as two separate individual units, in some embodiments, the monitoring and process controller units 628 and 620 may form a single integrated unit that is configured to carry out operations pertaining to the process controller 620 and the monitoring unit 628. In these embodiments, the single integrated unit may be coupled to the recovery unit 626 as well as the robotic arm 614.

Further, it may be noted that the examples, demonstrations, and process steps that may be performed by certain components of the present cleansing system 600, for example by the process controller 620 and the monitoring unit 628, may be implemented by suitable code on a processor-based system. To that end, the processor-based system, for example, may include a general-purpose or a special-purpose computer. It may also be noted that different implementations of the present specification may perform some or all of the steps described herein in different orders or substantially concurrently.

In certain embodiments, the cleansing system 600 may be made fully automated or semi-automated. In a non-limiting example, the process controller 620 may be configured to control operations of the robotic arm 614 and work in conjunction with the monitoring unit 628 to cleanse the intermediate component 602. In this example, once the intermediate component 602 is disposed in the holder 610, the process controller 620 may access pre-stored tool path instructions and initiate the cleansing process for the intermediate component 602.

It may be noted that the method of the present specification, such as the method of flow charts 400 and 500 of FIGS. 4 and 5, respectively, may be standalone cleansing techniques or may be used in conjunction with the existing processes used for cleaning additively manufactured components. By way of example, the methods of the present specification may be performed as an additional cleansing step post one or more other cleansing techniques, such as ultrasonic cleaning, and the like.

Although not illustrated, in some embodiments, two or more ultra high-pressure fluid jets may be deployed to cleanse the intermediate component. In some other embodiments, a single high-pressure fluid jet may be coupled with other water jets. Further, following the cleansing process, the cleansed product may be subjected to one or more process steps, such as, but not limited to, thermal treatment for strengthening, surface treatments to obtain a desirable surface finish, cold or hot isostatic pressure for densification, machining to creating high fidelity features, or the like.

While only certain features of the invention have been illustrated and described herein, many modifications and changes will occur to those skilled in the art. It is, therefore, to be understood that the appended claims are intended to cover all such modifications and changes as fall within the scope of the invention.

1. A method for removal of residual matter, the method comprising:
delivering an ultra high-pressure fluid jet to an intermediate additively manufactured three-dimensional (3D) component to dislodge and remove at least a portion of the residual matter from an internal surface of the intermediate additively manufactured 3D component, or from an external surface of the intermediate additively manufactured 3D component, or both, to form a cleansed additively manufactured 3D component.

2. The method of claim 1, wherein the residual matter comprises loose particles, partly sintered particles, agglomerates, or combinations thereof

3. The method of claim 1, wherein the ultra high-pressure fluid jet comprises water, a mixture of water and powder particles, an incompressible fluid, a mixture of the incompressible fluid and powder particles, an oil, a mixture of the oil and powder particles, or combinations thereof

4. The method of claim 1, wherein delivering the ultra high-pressure fluid jet comprises delivering the ultra high-pressure fluid jet in a continuous manner.

5. The method of claim 1, wherein delivering the ultra high-pressure fluid jet comprises varying an orientation, a standoff distance, or both, of the ultra high-pressure fluid jet and the intermediate additively manufactured 3D component with respect to one another while delivering the ultra high-pressure fluid jet.

6. The method of claim 1, wherein delivering the ultra high-pressure fluid jet comprises moving the ultra high-pressure fluid jet through space in accordance with a digital tool path instruction.

7. The method of claim 1, further comprising collecting an effluent, wherein the effluent comprises a jet fluid, washed-out particles of the residual matter, or a mixture of the jet fluid and the washed-out particles.

8. The method of claim 7, further comprising filtering the effluent to determine an amount of the washed-out particles in the effluent.

9. The method of claim 1, further comprising at least partly removing a leftover jet fluid from the cleansed additively manufactured 3D component.

10. The method of claim 9, wherein removing the leftover jet fluid further comprises subjecting the cleansed additively manufactured 3D component to a heat treatment, an air blast treatment, an electro assisted dissolution, a chemical dissolution, or combinations thereof.

11. A method for additively manufacturing a cleansed additively manufactured 3D component, the method comprising:
additively manufacturing an intermediate additively manufactured 3D component; and
removing at least a portion of residual matter from the intermediate additively manufactured 3D component by delivering an ultra high-pressure fluid jet to the intermediate additively manufactured 3D component to dislodge and remove at least a portion of the residual matter from an internal surface of the intermediate additively manufactured 3D component, or an external surface of the intermediate additively manufactured 3D component, or both, to form the cleansed additively manufactured 3D component, and wherein the ultra high-pressure fluid jet comprises a pressure of 10,000 psi to 70,000 psi.

12. The method of claim 11, wherein at least a portion of the residual matter is bonded to the internal surface, the external surface, or both the internal and external surfaces of the intermediate additively manufactured 3D component.

13. The method of claim 11, wherein the ultra high-pressure fluid jet comprises water, a mixture of water and powder particles, an incompressible fluid, a mixture of the incompressible fluid and powder particles, an oil, a mixture of the oil and powder particles, or combinations thereof.

14. A cleansing system comprising:
a chamber having a base and walls;
a holder disposed on the base of the chamber, wherein the holder is configured to receive an intermediate additively manufactured 3D component; and
an ultra high-pressure fluid jet configured to dislodge and remove at least a portion of the residual matter from an internal surface of the intermediate additively manufactured 3D component, or from an external surface of the intermediate additively manufactured 3D component, or both, to form a cleansed additively manufactured 3D component.

15. The cleansing system of claim 14, wherein the chamber further comprises a robotic arm for mounting the ultra high-pressure fluid jet.

16. The cleansing system of claim 14, further comprising a process controller coupled to the robotic arm and configured to control operation of the robotic arm.

17. The cleansing system of claim 16, wherein the process controller is configured to control operation of the cleansing system based on a recovered effluent.

18. The cleansing system of claim 14, further comprising a recovery unit configured to at least partly recover an effluent from the chamber.

19. The cleansing system of claim 18, wherein the recovery unit further comprises one or more filters.

20. The cleansing system of claim 18, further comprising a monitoring unit configured to monitor a recovered effluent from the recovery unit.
